(19) United States
(12) Patent Application Publication
(10) Pub. No.: US 2011/0078722 A1
(43) Pub. Date: Mar. 31, 2011

(54) METHOD FOR DISPLAYING ENHANCED VIDEO CONTENT

(75) Inventor: Bertrand WENDLING, ROLLE (CH)

(73) Assignee: NAGRAVISION SA, CHESEAUX-SUR-LAUSANNE (CH)

(21) Appl. No.: 12/889,703

(22) Filed: Sep. 24, 2010

(30) Foreign Application Priority Data
Sep. 25, 2009 (EP) EP 09171410.5

(51) Int. Cl. H04N 7/167; H04N 7/173

(52) U.S. Cl. 725/31; 725/116

(57) ABSTRACT

The present invention provides a solution to the problem of displaying enhanced video content from a remote server in situations where a connection to the remote server provides inadequate bandwidth to be able to do so. One solution involves pre-storing the enhanced video content locally, receiving a broadcast of a default format version of the enhanced content and displaying the enhanced content instead of the default format content. The present invention also provides a means for ensuring that such pre-stored content is only viewed at a predefined time and by viewers who are authorised to do so.

### INTRODUCTION

The present invention relates to the domain of video systems for displaying digital image data and more particularly to systems and methods for displaying enhanced digital video content such as high definition video content or 3-dimensional video content.

### STATE OF THE ART

Recording and playback of digital video content by consumers is now commonplace. Furthermore, demand for high definition video capability in such recording or playback is ever increasing. With more and more consumers having access to high definition video viewing equipment, coupled with the need to remain backward-compatible with standard definition formats, there has been a need to have the flexibility of choosing whether a particular video content be viewed in standard format or in high definition format. Indeed, much work has been done in developing systems and methods for storing video content on a limited-capacity storage medium such as a digital video disc (DVD) in a format which allows the consumer to choose whether he wishes to display the content in standard format or high definition format. For example, in United States Patent Application 2005/0185937A1 a method is described for storing a standard definition compatible video content on a storage medium as a base layer and further storing an enhancement layer comprising data which will allow the standard definition video content to be upgraded to high definition content.

Providing the capability of choosing to view video content as standard definition or high definition is therefore fairly straight-forward according to the state of the art provided the connection between the consumer's viewing equipment and the source of the high definition video content has a high enough bandwidth to be able to receive the high definition video content. This is usually the case in a system where the source is a DVD to which the viewing equipment is connected via a high-bandwidth connection. However, if the source of the high definition video is a broadcast center and the consumer's viewing equipment is fed by a receiver connected to the broadcast center by any of the usual means, such as terrestrial cable, satellite connection, RF transmission etc., then depending on the particular connection that exists between the receiver device and the broadcast center, the connection may or may not be capable of furnishing the required bandwidth to achieve good quality high definition video transfer from the broadcast center to the receiver.

Other methods have been used to provide enhanced video content, however not by improving the visual aspect of the content as would be the case if standard definition video were to be enhanced to high definition video, but by adding features to allow a viewer to obtain content related to the content being viewed. For example, the document US2002/162118 describes an interactive television system in which broadcast data can be enhanced with interactive data. For that purpose, a watermark is embedded in the broadcast data, the watermark containing an address of the interactive data. The receiver extracts the watermark and sends a request with the address contained in the watermark to an interactive center. In return the latter sends the interactive data. The interactive data is not supposed to enhance the visual aspect of the broadcast content but rather to provide a possibility of starting a dialog with a user with a view to providing additional data related to the broadcast content.

According to the document US 2007/266414, a broadcast program is cut into two sections, each section representing a complete part of the content but limited in time, one section being broadcast and the other section being sent during a point-to-point connection between the receiver and a head end. Each section can be viewed individually. The whole content is played back when one section is played back after the completion of the other section.

The present invention therefore aims to address the problem of a viewer being able to view enhanced video content broadcast from a broadcast center to a receiver where said receiver may not necessarily have a connection to the broadcast center with sufficiently large bandwidth to simultaneously receive and view said content.

### BRIEF SUMMARY OF THE INVENTION

The present invention provides a solution to the problem of being able to display, on a display unit (VDU), enhanced video content from a remote server in situations where the available bandwidth of a connection to the remote server does not permit to do so.

The invention provides a method for displaying enhanced video content corresponding to a broadcast session, said method using a multimedia unit comprising a data storage medium, said broadcast session comprising default format video content and a corresponding default identification tag, said method comprising the steps of:
receiving video material and an associated enhanced identification tag corresponding to the default identification tag by the multimedia unit, said video material being useful for generating said enhanced video content;
storing said video material and said enhanced identification tag in the data storage medium;
receiving said default format video content and default identification tag as part of the broadcast session from the broadcast center, said broadcast session taking place subsequently to the reception of the video material;
comparing, by the multimedia unit, the default identification tag with the stored enhanced identification tag;
if there is a match between the default identification tag and the enhanced identification tag, then using the stored video material to generate the enhanced video content;
displaying the enhanced video content on the display unit.

### BRIEF DESCRIPTION OF THE DRAWINGS

The present invention will best be understood by referring to the following detailed description of preferred embodiments when read in conjunction with the accompanying drawings, wherein:

FIG. 1 shows a schematic diagram of an embodiment of the present invention.

FIG. 2 shows a schematic diagram of a further embodiment of the present invention.

FIG. 3 shows a schematic diagram of, yet a further embodiment of the present invention.

FIG. 4 shows a schematic diagram of an embodiment of the present invention which includes techniques used in the Pay-TV domain using a security module.

### DETAILED DESCRIPTION

A given viewer of video content may have access to a broadcast service and may have a multimedia unit comprising a receiver and may also have a means for displaying enhanced video. A video content is a content representing a single video event such as a film, a television program, a documentary or any video content prerecorded at the management center. The video content may correspond with an item in an Electronic Program Guide describing the events available for a given channel. Whether or not the viewer is able to receive and view the enhanced video will depend on the bandwidth capability of his connection between the multimedia unit and the center from where the service is broadcast. This can mean that a significant proportion of the potential viewing population could be excluded from being able to view enhanced video content in spite of the fact that their viewing equipment allows them to do so.

A multimedia unit could be in the form of a set-top box, which is attached to a screen or it could be built into a TV set including a screen. Essentially, the multimedia unit extracts various services from a broadcast and processes the services for display.

Enhanced video formats usually require more data and therefore more bandwidth to transmit than the default format. One default format is commonly known as standard definition format. By enhanced video format it is meant a high-definition (HD) video content or a three-dimensional (3D) video content for example, i.e. a single video experience. It is not video content for which additional content is overlaid in order to bring in some further information which is related to the content. Another example of an enhanced video formats is Augmented Reality (AR). Augmented Reality includes such applications as head-up displays (HUD), virtual retinal displays, 3-D displays etc, wherein a live direct or indirect view of a physical real-world environment is augmented by virtual computer-generated imagery. Augmented reality can be described as an enhanced video format insomuch as the amount of data required to allow the video content to be properly displayed is significantly more than the amount of data required to display a default format such as standard definition. It is this aspect of the AR format which defines it as an enhanced format according to the present invention and not any aspect related to an ability to link to or add on features or content over and above the transmitted content.

By way of example of a situation where an embodiment of the present invention may be deployed, we make reference to the field of IPTV networks. In the so-called IPTV system or network, a broadcast service comes from a server, and viewers, who may or may not subscribe to the service, have access to multimedia units which are connected to the server via the internet enabling them to receive and view the broadcast service. IPTV systems are generally intended to be able to handle enhanced video transmission, and appropriately comprise a DSLAM or digital subscriber line access multiplexer. The DSLAM is a network device that connects multiple digital subscriber lines (DSL) to a high-speed internet backbone using multiplexing techniques and allows telephone lines to make faster connections to the internet. However the “last mile” of a connection between the subscriber and the DSLAM is often made of a simple balanced pair cable, which has higher attenuation at higher frequencies. For this reason the longer this “last mile” connection the lower the bandwidth. Local bandwidth conditions therefore experienced by a subscriber may vary between 25 Mbit/s for a balanced cable pair of a few hundred meters to 1 kbit/s for a balanced pair of a few kilometers.

As mentioned above, the present invention aims to provide a method for displaying enhanced video content corresponding to a broadcast session transmitted from a transmitter to a multimedia unit comprising a receiver, where a connection between the transmitter and the receiver may not necessarily have sufficient bandwidth to be able to simultaneously receive and display the enhanced video broadcast on the display were the broadcast session to directly comprise the enhanced video content. The broadcast session corresponds with a particular time slot during which the video content is broadcast. As mentioned above, although the main part of the connection between the transmitter and the receiver could be capable of handling high bandwidth data, there might be one part of the connection which does not have high bandwidth capabilities, thus rendering the connection as a whole unsuitable for such high bandwidth transmissions. It is worth noting that the invention is not restricted to IPTV networks, but can apply to any type of broadcasting network such as cable, satellite or conventional RF networks.

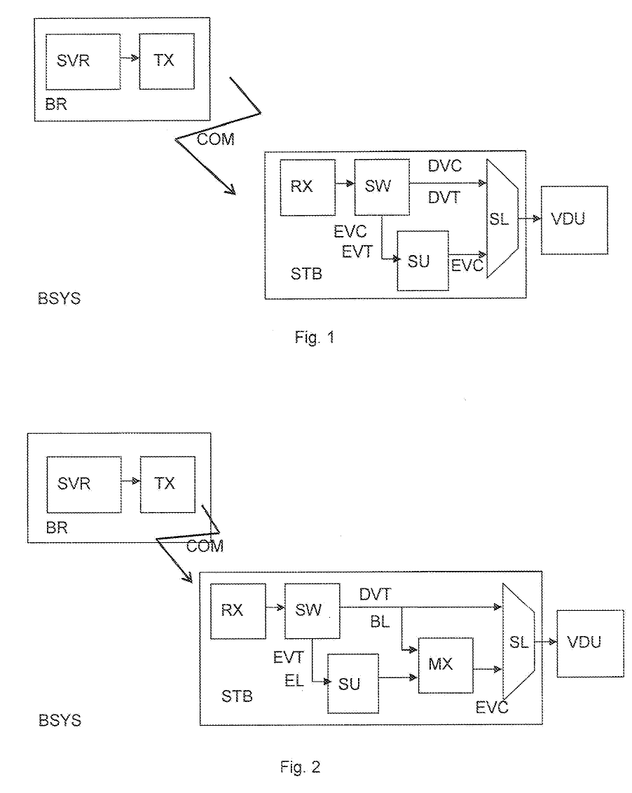

FIG. 1 illustrates how, according to an embodiment of the present invention, a viewer having access to a multimedia unit (STB) may view enhanced video content (EVC) from a broadcast center (BR) regardless of the fact that the bandwidth of his connection (COM) to the broadcast center (BR) would not normally allow him to receive and view such enhanced video content (EVC). The figure shows a broadcast system (BSYS) comprising a broadcast center (BR) and at least one multimedia unit (STB). The broadcast center (BR) comprises a server (SVR) and a transmitter (TX). The multimedia unit (STB) comprises a receiver (RX) and a preferably non-volatile storage medium (SU) (which is distinct from the buffer and other memory, which is usually volatile, in which received default format content (DVC) is stored as part of conventional processing) and is connected to a display unit (VDU). First the broadcast center (BR) transmits enhanced video content to the at least one multimedia unit (STB) via the connection (COM). This transmission is made at a data rate low enough for any multimedia unit (STB) in the system to be able to receive the transmission, for example at a data rate compatible with a default format video transmission. At this time the broadcast center (BR) also transmits an enhanced identification tag (EVT), used to identify the content (EVC). The multimedia unit (STB) receives the transmission (EVT, EVC), identifies it (SW) as being enhanced video, and stores the enhanced video content (EVC), along with the enhanced identification tag (EVT) onto the storage medium (SU). At some later time, a default format version (DVC) of the previously stored enhanced video content (EVC) is broadcast along with a default identification tag (DVT) identifying the content as default format video and corresponding to the previously stored enhanced identification tag (EVT). At this time the viewer's multimedia unit (STB) may select (SL) the previously stored enhanced version (EVC) of the content for display rather than displaying the currently transmitted default format version (DVC), thereby allowing the viewer to view the currently transmitted default format content as enhanced video.

It is worth noting that the enhanced video content and the default format video content need not come from the same place. Indeed, according to an embodiment of the present invention, there could be a server from which the enhanced video content is distributed and another server from which the default format content is broadcast. In this case we refer to an enhanced server (ESVR) upon which the enhanced video content is stored and a broadcast server (BSVR) from which the broadcast default format video content is taken. The two servers may of course reside in the broadcast center i.e. the two servers may indeed be realized as one unique server (SVR) or they may be remote from each other, with the multimedia unit having direct access to both servers.

The transmission of the enhanced video content may be made by made by the enhanced server in a broadcast manner as described above or, in the case where a direct (peer to peer) connection between the multimedia unit and the server exists, the transmission could be made on a one to one basis. Either the server initiates the transfer of the enhanced video content to the multimedia unit, i.e. a push configuration or the viewer initiates the transfer of the enhanced video content from the server. Indeed there may be a menu from which the viewer would select enhanced video content to store in his multimedia unit for future viewing whenever the default format is broadcast from the broadcast center.

It is worth noting that the transmission of the enhanced video content (EVC) would generally be made at a time when the multimedia unit (STB) is not being used to view a transmission, for example during the night. In an embodiment of the present invention the server (SVR) can detect when a viewer is not using the receiver (RX) on his multimedia unit (STB) and transmit enhanced video content (EVC) to that user at that time to be stored for later recall at a future time when the default format version of the video content (DVC) is being broadcast.

In another embodiment of the present invention, when the multimedia unit is put in standby mode, it can tune its receiver to listen on a particular channel for transmissions being made by the enhanced server. In this case the enhanced server would transmit all enhanced content from various sources, e.g. different channels, on this particular channel. Otherwise, if the multimedia unit stays on the channel which was last being used before going into standby mode, then it would receive enhanced content pertinent to that particular channel during the time that it is standby.

Another application in which an embodiment of the present invention may be deployed is in a situation where different versions of a video content are to be distributed to different viewers, perhaps based on geographical location, for example, each of the viewers will receive his respective version of the enhanced content to be stored in his multimedia unit. At the time the default format of the video content is broadcast, each viewer will be able to view his own respective version of the enhanced video content. In this case there might not necessarily be any enhancement in the quality of the enhanced content—the enhancement being that it is possible to view different versions of the same content—and therefore the invention, employed in this context, is not necessarily aimed solely at addressing a problem of bandwidth availability.

Enhanced video content can have a high value on the video market and as such it would not be desirable for such content to be forwarded from an intended viewer to another viewer, especially in systems wherein the intended viewer is a paying subscriber to the service which broadcasts the content whereas the other viewer is not a subscriber. For this reason, the storage medium within the multimedia unit, upon which the enhanced content is stored, or at least the part of the storage medium where the content is stored, is not directly accessible by the user. Access to the stored data (EVC, EVT) is restricted by the operating system. In this way the broadcast server can ensure that a viewer will not distribute the enhanced content and that he will only be able to view it when the appropriate default identification tag is received, i.e. when the default format version of the content is broadcast.

In another embodiment of the present invention, further means are employed to prevent the redistribution of enhanced video content which could be stored on a viewer's multimedia unit (STB). In this embodiment the enhanced video content is pre-processed to give at least two components known as an enhancement layer (EL) and a base layer (BL). Preferably the broadcast center in charge of managing the enhanced video content will perform the pre-processing, storing the two components separately. Instead of allowing the enhanced video content in its entirety to be pre-stored in a multimedia unit's storage medium, only the enhancement layer (EL) is transmitted from the broadcast center to be pre-stored in the multimedia unit's storage medium. This enhancement layer does not comprise enough data to allow for the enhanced video content to which it is related to be properly viewed and therefore there is no gain to be achieved in forwarding the stored enhancement layer from the multimedia unit to a third party.

According to an embodiment of the present invention in which the enhanced video content is reduced into enhancement layer (EL) and base layer (BL) components, the base layer (BL) may comprise simply the default video format. As mentioned previously the default video format could be standard definition video. In this embodiment, any of the techniques known in the state of the art may be used to combine (MX) the base layer (BL) and the enhancement layer (EL) to give the full high density version of the content, i.e. the enhanced video content (EVC) once the base layer (BL) is broadcast and matched to the enhancement layer (EL) via the enhanced identification tag (EVT) and the default identification tag (DVT). This embodiment is illustrated in FIG. 2.

In more general terms then, in the embodiments of the present invention thus far described, video material is pre-stored on the multimedia unit's storage medium. In some embodiments the video material comprises the entire enhanced video content, which when viewed gives a viewer a complete enhanced video viewing experience, such as high density video viewing for example. In embodiments of this type, when the corresponding default video content is received, the multimedia unit merely replaces the default content with the pre-stored video material. In other embodiments of the present invention the video material pre-stored on the multimedia unit's storage medium comprises only a component of the enhanced video content, the enhancement layer for example. The enhancement layer alone does not allow a viewer to experience the enhanced video viewing experience. In embodiments of this latter type, when the corresponding default video content is received, the pre-stored video material, i.e. the enhancement layer, is combined with the default video content, i.e. the base layer, which could be standard definition video content, to give the viewable enhanced video content. In this case the multimedia unit comprises means to synchronise the pre-stored video material with the default video content. The synchronization is done according to the methods commonly used in spatial or temporal scalability algorithms and may use Laplacian pyramid techniques.

Scalable video coding enables the achievement of a high quality video signal from one or more lower quality video signals. Scalable video coding can be in a time domain or in a spatial domain. Examples of scalable video coding are described in Annex G of the H.264/MPEG-4 AVC video compression standard. Scalable video coding involves the use of one or more hierarchically generated video signals of low resolution based on a high resolution video signal. The hierarchical signals are generated by taking into consideration any characteristics which are similar across the different hierarchical layers. To obtain a high resolution video signal from hierarchically coded layers, a signal in an upper layer in the hierarchy and a signal in a lower layer are multiplexed into a single bit-stream. Synchronization between the lower layers and the upper, or enhanced, layers is based on a timestamp as well as spatial information comprised in the hierarchical signals.

As a further protection against unauthorised use of the pre-stored video material i.e. the enhanced video content or the enhancement layer, the enhanced identification tag may further comprise an expiry code, or a dedicated expiry tag could be used, indicating a date or a time after which the video material may no longer be used. In such a system, a flush or erase of such expired video material could be done by the operating system thus ensuring the material may no longer be used.

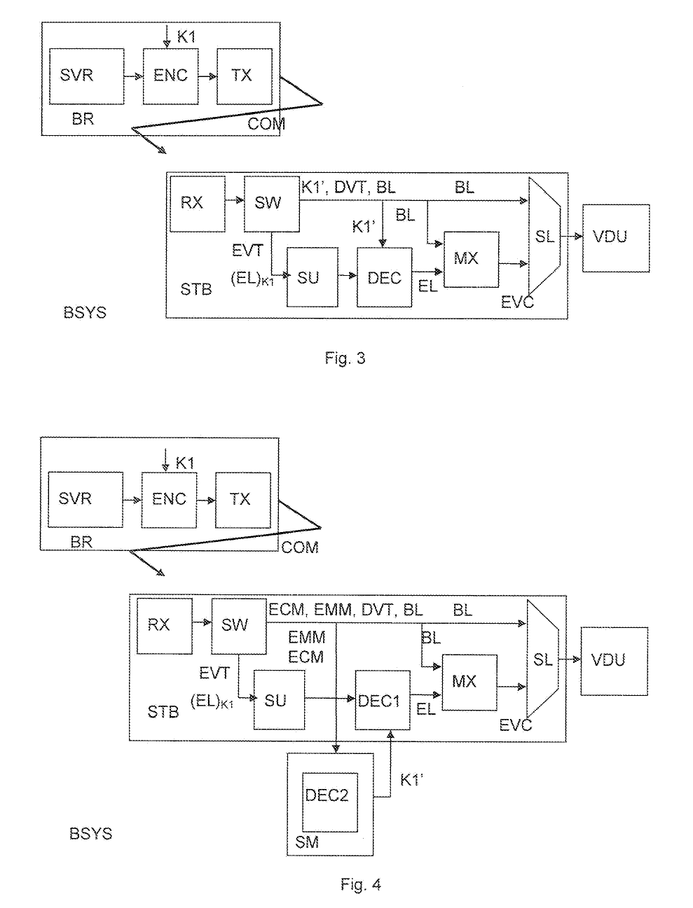

Continuing with the notion of increased security, in another embodiment of the present invention, instead of transmitting the enhanced video content (EVC) or the enhancement layer (EL) in clear, it may be transmitted in encrypted form, encrypted under an encryption key K1, ((EVC)_{K1} or (EL)_{K1}), as illustrated in FIG. 3. In this embodiment the multimedia unit further comprises a decryption unit (DEC) to decrypt the encrypted content. As in any encryption/decryption system, there is a decryption key (K1′) which matches an encryption key (K1). According to whether the encryption system uses a symmetric or an asymmetric algorithm, the decryption key (K1′) will either be the same as the encryption key (K1) or forming a pair of public and private keys. The key (K1′) to decrypt the encrypted enhancement layer or enhanced video content would be transmitted as part of the default identification tag (DVT) when the corresponding default format broadcast is made, thus guaranteeing that the enhanced video content could only be viewed at the time the default format version is broadcast. Similarly, a dedicated decryption key tag could be used to transmit the decryption key instead of using the default identification tag.

Systems and methods are known from the domain of Pay-TV wherein a multimedia unit may be associated with a security module (SM), within which security operations are carried out. The security module (SM) may take one of several forms, including a microprocessor card, a smart card or more generally an electronic module, perhaps in the form of a key or a badge etc., and is generally removable and connectable to the multimedia unit (STB). This type of security module may either have electrical contacts to form a connection between the multimedia unit and the security module or may be contactless. Other forms include an integrated circuit chip soldered into the multimedia unit in a tamperproof manner or it could be integrated on a circuit which has another function such as descrambling or it may even be realized as software rather than hardware. The type of security operations which are carried out in the security module are the decryption (DEC2) of ECMs (entitlement control messages), the processing of EMMs (entitlement management messages), the storage of decryption keys (K1′) decrypted (DEC2) from the ECMs and the recording of different rights. The decryption of encrypted content may also be carried out in the security module although in most cases it is done outside of the security module. A further embodiment of the present invention, illustrated in FIG. 4, borrows the techniques described above to give a multimedia unit (STB) with its associated security module (SM). The video material is transmitted by the broadcast center in encrypted format ((EVC)_{K1} or (EL)_{K1}) and pre-stored in the storage medium (SU) of the multimedia unit (STB) along with its associated enhanced identification tag (EVT). When the corresponding default format video content (DVC) is broadcast, with its default identification tag (DVT) corresponding to the pre-stored enhanced identification tag (EVT), the multimedia unit (STB) can fetch the decryption keys (K1′) from the security module (SM). The multimedia module can then decrypt (DEC1) the encrypted video material. Appropriate EMMs may be broadcast in order to configure the security module with the rights to which it is entitled according to the type of subscription the viewer has paid for. For example a subscriber may buy the rights to watch certain channels or certain films or certain rights may be time-bound etc. Similarly, ECMs are broadcast along with the default format video content (DVC) in order for the security module with the appropriate rights to be able decrypt the ECMs to obtain the necessary control words to give the decryption keys (K1′). The decryption keys are passed to the multimedia unit so that the encrypted content may be decrypted in the multimedia's decryption unit, thus enabling the subscriber to view the enhanced video content (EVC).

The security module can comprises a credit that can be used when the user upgrades the default video content to the enhanced content. The viewer is prompted by a message when the default identification tag matches a pre-stored enhanced identification tag. The message comprises the billing information informing the user about the amount of credit needed for this upgrade. As soon as the user has given his approval, the security module proceeds with the credit balance modification and returns the decryption key to the multimedia unit, thus allowing the latter to decrypt the enhanced content for display.

As well as the rights described above, the present invention allows for further usage rules to be configured and verified at the multimedia unit or within the security module. For example usage rules may include being able to watch any default format broadcast or to record it in a user-accessible region of the storage medium or an OS-accessible region of the storage medium whereas it may only be possible to watch an enhanced version of the broadcast or to store it onto an OS-accessible region of the storage medium but not a user-accessible region.

In another embodiment of the present invention the server (SVR) can predict which video material should be pushed to a particular viewer. In this embodiment each multimedia unit (STB) stores statistics of which content has been viewed by the viewer. This information is sent back to the server and used by the server to make a viewing profile for the particular viewer. The server further has access to a profile for each of the pieces of enhanced video content that it can push to viewers. By comparing the profiles of the video content with the viewing profile of each user, the server can select which video material to send to which viewer with a reasonable amount of confidence that such video material will be useful to the viewer in allowing him to view video content in enhanced video format.

In this embodiment, the multimedia unit, while in standby mode, will connect to the enhanced server for the determination of the supposed enhanced video content that will be of interest to the viewer. The enhanced server then downloads the relevant video material to the multimedia unit for future synchronization with the broadcast content.

In yet another embodiment of the present invention, the video material may be loaded onto the storage medium via some means other than by being transmitted from the broadcast center to the receiver at a low-enough data rate to be properly received. For example, the video material could be an enhancement layer component of high definition video content and it could be loaded onto the storage medium by being read directly via a disk drive. The video material could even be in encrypted format.

1. A method for displaying, on a display unit, enhanced video content corresponding to a broadcast session allocated at a predetermined time slot, said method using a multimedia unit comprising a data storage medium, said broadcast session comprising default format video content and a corresponding default identification tag, said method comprising the steps of:
receiving video material and an associated enhanced identification tag corresponding to the default identification tag by the multimedia unit, said video material being useful for generating said enhanced video content;
storing said video material and said enhanced identification tag in the data storage medium;
receiving said default format video content and default identification tag as part of the broadcast session from the broadcast center, said broadcast session taking place subsequently to the reception of the video material;
comparing, by the multimedia unit, the default identification tag with the stored enhanced identification tag;
if there is a match between the default identification tag and the enhanced identification tag, then using the stored video material to generate the enhanced video content; and
displaying the enhanced video content on the display unit.

2. The method according to claim 1, wherein the stored video material represents the enhanced video content, the enhanced video content replacing the received default format video content.

3. The method according to claim 1, wherein the stored video material represents an enhancement layer and the default format video content represents a base layer and wherein said enhancement layer and said base layer are combined to give the enhanced video content.

4. The method according to claim 3, wherein the default format video content provides video data of a first resolution and the enhanced video content provides video data allowing to enhance the default format video content to a second resolution according to a scalable video coding scheme, the second resolution providing more detail than the first resolution.

5. The method according to claim 1, wherein the video material is received from an enhanced video server and the default format video content is received from a broadcast server.

6. The method according to claim 5, wherein the enhanced video server and the broadcast server are separate from each other.

7. The method according to claim 5, wherein the enhanced video server and the broadcast server form one unique server.

8. The method according to claim 5, wherein the video material is received by the multimedia unit upon request from the multimedia unit to the enhanced video server.

9. The method according to claim 5, wherein the video material is received by the multimedia unit following an initiative taken by the enhanced video server.

10. The method according to claim 1, wherein at least part of said video material is encrypted under an encryption key to give encrypted video material at the broadcast center, the latter being in charge of broadcasting an equivalent key to the encryption key, and wherein said multimedia unit further comprises a decryption unit, said method further comprising a step of decrypting said encrypted video material using said decryption key to give said at least part of said video material.

11. The method according to claim 10, wherein said multimedia unit further comprises a security module, said broadcast further comprises at least one ECM message, said ECM message comprising a cryptogram of said decryption key, said method further comprising a step of decrypting the ECM message using the security module to obtain the decryption key.

12. The method according to claim 1, wherein said storage medium comprises at least one protected area and said video material or said encrypted video material is stored in said protected area.

13. The method according to claim 1, wherein said multimedia unit further receives an expiry code corresponding to the received video material or the received encrypted video material, said expiry code indicating an expiry date for said video material or said encrypted video material, said multimedia unit erasing the video material or the encrypted video material when the expiry date is past.

14. The method according to claim 1, wherein said multimedia unit further receives at least one usage rule instructing the multimedia unit as to which video material or encrypted video material may be stored and where it may be stored.

15. The method according to claim 1, wherein said video material or said encrypted video material is received when the receiver is not being used to receive a broadcast.

16. The method according to claim 1, wherein the data storage medium is non-volatile.
